(19) United States
(12) Patent Application Publication
(10) Pub. No.: US 2026/0328397 A1
(43) Pub. Date: Oct. 22, 2026

(54) OPERATING A DOMESTIC COOKING APPLIANCE WITH AT LEAST ONE COOKING CHAMBER CAMERA

(71) Applicant: BSH Hausgeräte GmbH, Munich (DE)

(72) Inventors: Ramon Peinado Adiego, Zaragoza (ES); Hans-Martin Eiter, Kirchweidach (DE); Marion Bosold, St. Georgen (DE); Angelika Oberstaller, Traunstein (DE); Magdalena Wolz, Traunreut (DE); Hector Martinez Landa; Ana Belen Cambra Lines, Zaragoza (ES); Alejandro Rituerto Sin, Zaragoza (ES); Jorge Escribano Jimenez, Zaragoza (ES); Sergio Gracia Bosque, Zaragoza (ES); Soraya Santana De la Fe, Zaragoza (ES); Blanca Grillo Zamora, Zaragoza (ES)

(21) Appl. No.: 19/109,634

(22) PCT Filed: Sep. 27, 2023
(86) PCT No.: PCT/EP2023/076660

§ 371 Date: Mar. 7, 2025

(30) Foreign Application Priority Data
Oct. 3, 2022 (EP) 22382923.5

(51) Int. Cl. F24C 7/08; G06T 7/60

(52) U.S. Cl. CPC F24C 7/085; G06T 7/60

(57) ABSTRACT

In a method for operating a household appliance, a plurality of images are generated from a treatment chamber of the household appliance at time intervals by a treatment chamber camera with at least one variable camera setting. At least two of the images are used for at least two different purposes, and a camera setting of the treatment chamber is varied as a function of purpose.

The invention relates to a method for operating a household appliance with a treatment chamber and at least one treatment chamber camera, wherein a plurality of images are generated at time intervals by means of the at least one treatment chamber camera and at least two of the images are used for at least two different image-based purposes. The invention also relates to a household appliance, having a treatment chamber and at least one treatment chamber camera with at least one variable camera setting, wherein the household appliance is set up to carry out the method. The invention can be applied advantageously in particular to household cooking appliances, specifically ovens, in particular conventional ovens.

Household appliances with a treatment chamber and at least one treatment chamber camera, e.g. conventional ovens with a cooking chamber camera or refrigerators with a refrigeration chamber camera (referred to as CiF, camera in fridge) are known in principle. Specifically in the case of cooking appliances it is known that the position of food being cooked can be identified by image-assisted analysis and the degree of browning can then be determined based on the image segment showing the food being cooked. It is also known that the nature of the food being cooked can be determined by image analysis.

It is the object of the present invention to at least partially overcome the disadvantages of the prior art and in particular to offer an option that is particularly simple to achieve through design measures, to use images of a treatment chamber, in particular a cooking chamber, of a household appliance for different purposes.

This object is achieved according to the features of the independent claims. Preferred embodiments will emerge in particular from the dependent claims.

The object is achieved by a method for operating a household appliance with a treatment chamber and at least one treatment chamber camera with at least one variable camera setting, wherein
a plurality of images are generated at time intervals by means of the at least one treatment chamber camera and
at least two of the images are used for at least two different purposes,
   wherein
at least one camera setting of the at least one treatment chamber camera is varied as a function of purpose.

This has the advantage that images for different image use purposes can be supplied with optimized camera settings in each instance using the same camera. This in turn reduces costs compared with an arrangement in which different cameras or camera hardware is/are provided for different purposes. It also advantageously avoids any loss of precision or quality when an image is used for specific purposes. In a further advantage storage space and computing power can be kept to a minimum if the image quality is only as good as is required for the specific purpose. New image-based purposes can also advantageously be added with a software update without adversely affecting the performance for existing purposes.

This method utilizes the fact that camera settings or image parameters, such as luminous intensity, color channels, number of pixels and/or image resolution, significantly influence image processing algorithms that use them. It also utilizes the fact that the maximum scanning frequencies of cameras are generally higher than the intervals for image capture required for specific purposes in household appliances. The camera settings can therefore be multiplexed between multiple settings or sets of settings to record images with different camera settings for different purposes.

The treatment chamber is provided to treat, for example to cook, clean, chill, etc. items to be treated by the household appliance, such as food, dishes, laundry, etc. The treatment chamber can have a, for example front, loading opening, which can be closed by means of a door. The treatment chamber camera is designed and set up to capture images of the treatment chamber, in particular also of items present in the treatment chamber. A household appliance can have one or more cameras.

The treatment chamber camera is in particular an image point or pixel-based camera, in particular a digital camera. In one development the digital camera is a color camera, in other words it captures colored images, e.g. RGB or HSV images. At least one camera setting of the camera can be varied, in particular using a control facility of the household appliance. The capturing of an image can be initiated by means of the control facility for example. In one development the camera has a data processing facility for post-processing images, for example for image compression, setting color depth, and so on. In one development a data processing facility for image post-processing is an independent unit or is integrated in another functional unit of the household appliance, for example its control facility. The camera can then also be seen as a distributed system or system camera, in which image capture and image post-processing are distributed spatially over a number of components of the household appliance to achieve the ultimate image. Camera settings can refer in particular to settings for image capture per se (e.g. an exposure time) and/or settings on the data processing facility for image post-processing (e.g. a compression ratio). The treatment chamber camera can be located in the treatment chamber, e.g. on a wall of the treatment chamber, for example on the ceiling or door, or it can be arranged outside the treatment chamber and see into the treatment chamber for example through a viewing window, e.g. a window in the door or a porthole.

The use of an image for a specific purpose means in particular that the image is used for a specific functionality of the cooking appliance that utilizes the image. The “purpose” can also be referred to as a (cooking appliance) functionality, application, application instance, intended use or intended application.

In one embodiment the at least one camera setting comprises at least one camera setting from the group of image resolution, compression ratio, color depth, white balance, sensor gain, gamma correction, file format of image (e.g. PNG, GIF and/or RGB, HSV, NC-F image etc.), use of flash or flash light, lens setting, if the treatment chamber camera has a settable lens, and/or exposure time. The at least one camera setting is however not limited hereto and can comprise further camera settings.

At least one camera setting can be predetermined in a fixed manner for at least one purpose, in particular can always be the same for said purpose. At least one camera setting can be predetermined for at least one purpose for a current cooking operation as a function of at least one further parameter, e.g. a type of treatment, a type of food being cooked and/or the presence of specific items in the cooking chamber, e.g. baking parchment, etc.

Image resolution can correspond for example to a generic image resolution of a sensor element of the camera, e.g. a CMOS sensor, e.g. 1024×768 pixels. Image resolution can also correspond to an image resolution scaled down—for example by image post-processing—e.g. 640×480 pixels. A low resolution advantageously reduces image processing time, data size and data transfer volume.

The compression ratio can be zero (no compression) or greater than zero (compressed image). The compression ratio zero is also referred to in the following as no compression or without compression. Compression can be achieved by appropriate processes known in principle, e.g. JPEG, MPEG, PNG, WebP lossless, GIF etc., with which it is typically possible to set the compression ratio or number of pixels. It is however also possible only to select between no compression and compression to a specific image size or number of pixels. Compression can be lossless or lossy. A predetermined compression ratio (not zero) advantageously reduces image processing time, data size and data transfer volume. A predetermined compression ratio (not zero) also means that no image information relevant for determining the state of the food being cooked is lost, in particular if the predetermined compression ratio is selected—for example by experimental determination—so that adequate image information is available for carrying out the specific purpose.

Reducing the color depth can also advantageously reduce image processing time, data size and data transfer volume.

Setting the white balance and/or exposure time to the same values for image capture for specific purposes can be advantageous for example, to generate a set of images which can be particularly readily compared within the same cooking process. This is particularly advantageous when capturing images to determine a degree of browning or browning progression. A further advantage is that the camera settings for such images can be adjusted particularly easily based on training data so the images can also be used easily by AI systems.

In one embodiment the household appliance is a household cooking appliance, in particular an oven, specifically a conventional oven, the treatment chamber is a cooking chamber and the treatment chamber camera is a cooking chamber camera.

In one embodiment the different purposes comprise at least two purposes from the following group:
geometric food identification of food being cooked in the cooking chamber;
substantive food identification of food being cooked in the cooking chamber;
identification of a state of food being cooked in the cooking chamber;
identification of soiling of the cooking chamber;
identification of the insertion level of the food being cooked;
display of at least one image for a user;
retention for subsequent data analysis.

This advantageously covers a number of options for the use of a camera with optimized camera settings.

Geometric food identification of food being cooked in the cooking chamber means in particular that the image region showing the food being cooked is to be identified in an image. This in particular facilitates identification of a state of food being cooked in the cooking chamber.

Substantive food identification of food being cooked in the cooking chamber means in particular that the type of food being cooked is to be identified (automatic food identification).

Identification of a state of food being cooked in the cooking chamber means in particular that the cooking state or cooking phase of the food being cooked is to be identified, for example thawed, cooking initiated, cooked through, etc. or, specifically in the case of dough, whether it is still in the rising phase or in the browning phase, etc.

Identification of soiling of the cooking chamber means in particular that the extent to which a cooking chamber wall, a surface of a cooking chamber light facing the cooking chamber (e.g. a protective window of a light or a surface of the light itself facing the cooking chamber, e.g. a light guide of the light) and/or a surface of the camera facing the cooking chamber (e.g. its lens) is soiled, for example coated with grease, is to be identified.

Identification of the insertion level of the food being cooked means in particular that the insertion level, out of a number of possible insertion levels, at which a holder holding the food to be cooked has been inserted or placed is to be identified.

The display of an image for a user means in particular that one or more images are to be displayed for the user from a display unit, for example as a single image, group of images or image sequence (e.g. video, for example also in the form of a time-lapse video of images captured at time intervals during the cooking process). The display unit can be a display unit of the household appliance or a display unit of an external unit, such as a smartphone, tablet, etc.

Retention for data analysis means in particular that an image or image sequence is to be evaluated. This data analysis can be performed at a later time after the cooking process. For retention for data analysis one or more images can be stored in a data storage unit of the household appliance or in an external data storage unit. The data analysis can be used for example to identify user presence, to train AI systems, etc.

In one embodiment the state of the food being cooked in the cooking chamber comprises at least one state from the group of degree of browning on a surface of the food being cooked and/or volume or change in volume of the food being cooked. This is particularly advantageous to determine a current degree of cooking and/or to determine the end of cooking time.

In one embodiment the at least one image with high resolution, without image compression and with automatically set exposure time is generated for a first purpose. This is advantageous for example if the first purpose is to display a high-quality image for a user and/or to use the images to determine the food being cooked.

In one embodiment a number of images with high resolution, a predetermined compression ratio and with an automatically set exposure time are generated to produce an image sequence. This has the advantage that an image sequence with a low data volume can be generated, in which the individual images can be particularly easily identified by a user.

In one embodiment at least one image with low resolution, a predetermined compression ratio, a predetermined exposure time and with a predetermined white balance is generated to identify the state of the food being cooked. The low resolution advantageously reduces image processing time, data size and data transfer volume. The predetermined compression ratio advantageously ensures that it is not increased to a degree where image information relevant for determining the state of the food being cooked is lost. The predetermined exposure time and/or the predetermined white balance advantageously ensure(s) that a set of images can be generated that can be readily compared within the same cooking process. This is particularly advantageous when capturing images to determine a degree of browning or browning progression.

In one embodiment at least one image with low resolution, a predetermined compression ratio and reduced color depth is generated to identify the insertion level of the food being cooked. The low resolution and reduced color depth advantageously reduce image processing time, data size and data transfer volume. The predetermined compression ratio advantageously ensures that no image information relevant for determining the state of the food being cooked is lost. Exposure time can be set automatically or predetermined.

In one embodiment the image generated to identify the insertion level is generated as a grayscale image. This advantageously reduces image processing time, data size and data transfer volume still further, in particular if an algorithm is used, in which color information is not required to determine insertion height.

In one embodiment at least one image with predetermined resolution, a predetermined compression ratio and reduced color depth is generated to identify the soiling of the cooking chamber. When identifying the soiling of the cooking chamber major brightness fluctuations can occur, for example due to the contents of the cooking chamber, e.g. between an empty cooking chamber with dark walls and a cooking chamber in which an insertion level is lined with baking parchment. To take this into account, a number of images can be captured with different exposure times for example. Exposure time can be set automatically or predetermined.

In one development what is referred to as an HDR (High Dynamic Range) image is generated from a series of images with different exposure times. The interval between the images captured for this purpose here is advantageously short. This can be achieved for example by capturing images with no delay time between image captures.

In one development at least one image is stored for data analysis. In particular images for all purposes or just for at least one of the purposes can be stored for data analysis.

In one embodiment at least one image with low resolution, a predetermined compression ratio and/or a predetermined exposure time is generated for retention for data analysis.

In one embodiment the at least one generated image for retention for subsequent data analysis is sent to an external unit is sent to an external unit, e.g. to a smartphone, network server and/or cloud computer.

In one embodiment the following take place for example during a cooking process or cleaning process (e.g. pyrolysis, catalytic self-cleaning or manual cleaning)
deciding to capture an image with a specific purpose,
supplying or retrieving the camera settings associated with said specific purpose,
configuring the at least one treatment chamber camera according to the supplied camera settings,
generating (in particular capturing and if necessary post-processing) the image and
supplying the generated image for use for the specific purpose.

A specific set of camera settings can be assigned to every image capturing purpose, these being stored retrievably in a data storage unit and being supplied by this.

That the generated image is supplied for use for the specific purpose can mean that control of a cooking process or cleaning process is adjusted based on the generated image—and optionally further images generated for the same purpose—e.g. at least one cooking parameter (e.g. a cooking chamber temperature) is adjusted, the cooking process is terminated when the end of the cooking time is reached, there is a switch between cooking phases with different cooking parameter settings, etc.

In one development the purpose of the image capture is stored as additional information relating to a respective image. This allows the images to be organized according to purpose and analyzed in a purpose-specific manner in a data storage unit. In one development the camera settings used for a respective purpose are stored with a link to the image, e.g. as metadata.

The object is also achieved by a household appliance having a treatment chamber and at least one treatment chamber camera with at last one variable camera setting, wherein the household appliance is set up to carry out the method as described above. The household appliance can be configured in the same manner as the method and has the same advantages.

The household appliance is in particular a household cooking appliance, specifically a conventional oven, optionally with microwave and/or steam treatment function and/or automatic self-cleaning function (pyrolysis, catalytic self-cleaning, etc.).

The properties, features and advantages of the present invention described above and the manner in which these are achieved will become clearer and more readily understandable in conjunction with the following schematic description of an exemplary embodiment described in more detail in conjunction with the drawings, in which:

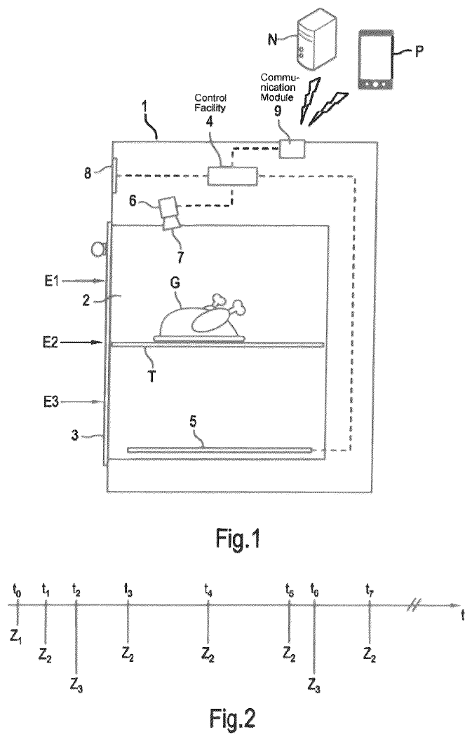

FIG. 1 shows a simplified outline of a sectional side view of a household appliance in the form of a conventional oven;

FIG. 2 shows a timeline in the form of possible image capture times over a time t; and

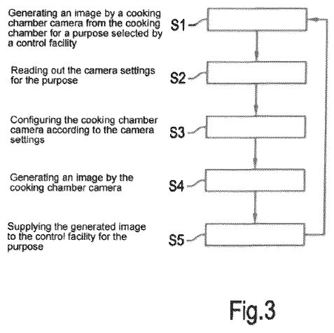

FIG. 3 shows a possible embodiment of the inventive method.

FIG. 1 shows a simplified outline of a sectional side view of a cooking appliance in the form of a conventional oven 1. The oven 1 has a cooking chamber 2, the front loading opening of which can be closed by a pivotable door 3. The cooking chamber 2 has a number of insertion levels E1 to E3, into which a food holder T, for example a baking sheet or wire rack shelf can be inserted. A food to be cooked G can be placed on the food holder T; in this instance at insertion level E2. The oven 1 also has a control facility 4 to carry out operating processes such as cooking and cleaning processes, as shown here by way of example by an electrical bottom heating unit 5.

The control facility 4 is also set up, e.g. programmed, as a data processing facility to carry out the method. A cooking chamber camera 6 in the form of a digital color camera is connected to the control facility 4 for data purposes and can in particular capture images from the cooking chamber 2 and send them to the control facility 4. A lens 7, which is part of the lens system of the camera 6 faces the cooking chamber 2. In one development the lens system with the lens 7 can be adjusted, e.g. in respect of focal point and/or image distance, etc.

The oven 1 also has an operating panel 8 with an in particular touch-sensitive screen (touchscreen), on which images or segments thereof captured by the camera 6 can also be displayed in one embodiment.

The oven 1 can also be equipped with a communication module 9, by way of which data (in particular including the images or image data) can be transferred from the control facility to an external unit such as a user terminal, in particular a mobile user terminal, for example a smartphone P or tablet etc. and/or to a network server N or cloud computer. The communication module 9 can comprise for example an Ethernet module, a WLAN module, a Bluetooth module, etc.

FIG. 2 shows a timeline in the form of possible image capture times over a time t that can be generated for example by means of the cooking chamber camera 6 from FIG. 1. Images for three different purposes Zᵢ, where i=1, . . . , 3, are generated here by way of example, for example for

Purpose Z₁.: identification of the soiling of the cooking chamber 2 by capturing an image before or at the start of a cooking process with a predetermined resolution, a predetermined compression ratio, an automatically set exposure time and with a reduced color depth.

Purpose Z₂: generation of an image sequence by generating a number of images with a high resolution, a predetermined compression ratio and with an automatically set exposure time at, in particular temporally equidistant, times t₁, t₃, t₄, t₅ and t₇, etc. These images can be stored for example in a data storage unit of the oven 1 (e.g. in a data storage unit of the control facility 4) and be shown at the user's request on the display unit of the operating panel 8 and/or after transfer by way of the communication module 9 on the smartphone P.

Purpose Z₃: control of the cooking process by browning identification, in particular to determine an end of cooking time and termination of the cooking process when the end of cooking time is reached by generating a number of images with a low resolution, a predetermined compression ratio, a predetermined exposure time and with a predetermined white balance at the, here in particular temporally equidistant, times t₂ and t₆, etc.

FIG. 3 shows a possible embodiment of the inventive method, which is explained in more detail by way of example with reference to the oven 1.

With the method it is decided by means of the control facility 4 in a step S1 to generate an image by means of the cooking chamber camera 6 at a time tᵢ for an associated purpose Zᵢ, e.g. to control the cooking process according to purpose Z₃.

In a step S2 the control facility 4 reads out the associated camera settings supplied for this purpose Zᵢ in an, optionally internal, data storage unit (not shown) and transfers them to the cooking chamber camera 6. For purpose Z₃ the camera settings can be for example a specific image resolution lower than the highest possible image resolution and identical for all images for the purpose Z₃, a predetermined compression ratio greater than zero and identical for all images for the purpose Z₃ and/or a predetermined white balance identical for all images for the purpose Z₃.

In a step S3 the cooking chamber camera 6 is configured according to these camera settings.

In a step S4 an image is generated by means of the cooking chamber camera 6. Image generation can in particular comprise image capture by means of an image sensor of the cooking chamber camera 6 and image post-processing of the raw image captured by the image sensor. Image post-processing can be performed in the cooking chamber camera 6, e.g. in a data processing facility thereof, or it can be performed in a different component of the oven such as the control facility 4.

In a step S5 the generated image is supplied to the control facility 4 for use for the specific purpose Zᵢ, in that the generated image is transferred from the cooking chamber camera 6 to the control facility 4, for example to control the cooking process by browning identification based solely on the images captured at times t₂ and t₆.

### The Method Then Returns to Step S1.

This method corresponds to a “multiplexing” of the camera settings of the cooking chamber camera 6 as a function of the purposes for which the images are used.

The present invention is of course not limited to the exemplary embodiment shown.

For example an image can be captured before or at the start of the cooking process to determine the insertion level E1-E3 at which the food holder T has been inserted. The control facility 4 can then vary the heating power introduced into the heating units of the cooking chamber 2, for example the bottom heating unit 4, at least one top heating unit, a hot air heating unit, etc. as a function of the selected insertion level E1-E3.

For example an image can be captured before or at the start of the cooking process to determine the position of the food being cooked 6 in the image. In one variant to determine the state of the food being cooked G only the pixels showing the food being cooked G are evaluated.

For example an image can be captured before or at the start of the cooking process to determine the type of food being cooked 6, e.g. chicken, bread dough, pizza, etc. The control facility 4 can then be set up for example to adjust the cooking process automatically based on the identified type of food being cooked G, for example adjusting a cooking chamber temperature and its profile, etc. Identification of the food being cooked can take place using artificial intelligence (AI) methods, for example using a neural network. It is particularly advantageous here if the position of the food being cooked 6 has been determined beforehand in the image.

In addition or as an alternative to the degree of browning, images can also be captured to determine a volume or change in the volume of the food being cooked G. This is particularly advantageous for dough, e.g. bread dough, to distinguish between a rising phase and a browning phase. The control facility 4 can then be set up for example to adjust the cooking process automatically based on the identified phases or phase ends.

Generally “one” can refer to one or a plurality, in particular in the sense of “at least one” or “one or more”, unless this is specifically excluded, for example by the expression “just one”, etc.

Also a figure can cover the specific number stated as well as a standard tolerance range, unless specifically excluded.

### LIST OF REFERENCE CHARACTERS

1 Oven
2 Cooking chamber
3 Door
4 Control facility
5 Bottom heating unit
6 Cooking chamber camera
7 Lens
8 Operating panel with display unit
9 Communication module
E1-E3 Insertion levels
G Food being cooked
N Network server
P Smartphone
S1-S5 Method steps
t Time
tᵢ Times for generation of images
T Food holder
Zᵢ Purposes

1-15. (canceled)

16. A method for operating a household appliance, the method comprising:
generating a plurality of images from a treatment chamber of the household appliance at time intervals by a treatment chamber camera with at least one variable camera setting;
using at least two of the images for at least two different purposes; and
varying a camera setting of the treatment chamber as a function of purpose.

17. The method of claim 16, wherein the camera setting comprises at least one camera setting from the group consisting of
image resolution;
compression ratio;
color depth;
white balance;
sensor gain;
exposure time;
gamma correction;
file format of image;
use of flash; and
lens setting, when the treatment chamber camera has a settable lens.

18. The method of claim 16, wherein the household appliance is a household cooking appliance, the treatment chamber is a cooking chamber, and the treatment chamber camera is a cooking chamber camera.

19. The method of claim 18, wherein the household cooking appliance is an oven.

20. The method of claim 18, wherein the at least two different purposes comprise at least two purposes from the group consisting of:
geometric food identification of food being cooked in the cooking chamber,
substantive food identification of food being cooked in the cooking chamber,
identification of a state of food being cooked in the cooking chamber,
identification of soiling of the cooking chamber,
identification of an insertion level of the food being cooked,
display of an image for a user, and
retention for data analysis.

21. The method of claim 20, wherein the state of the food being cooked in the cooking chamber comprises at least one state from the group consisting of degree of browning on a surface of the food being cooked, and volume or change in volume of the food being cooked.

22. The method of claim 16, further comprising generating for one of the at least two different purposes at least one of the at least two images with a high resolution, without image compression, and with an automatically set exposure time.

23. The method of claim 16, further comprising producing an image sequence by generating a number of images with high resolution, a predetermined compression ratio, and with an automatically set exposure time.

24. The method of claim 20, further comprising identifying the state of the food being cooked by generating at least one image with low resolution, a predetermined compression ratio, a predetermined exposure time, and with a predetermined white balance.

25. The method of claim 20, further comprising identifying the insertion level of the food being cooked by generating at least one image with low resolution, a predetermined compression ratio, and reduced color depth.

26. The method of claim 25, further comprising storing the image generated to identify the insertion level as a grayscale image.

27. £ (New) The method of claim 20, further comprising identifying the soiling of the cooking chamber by generating at least one image with a predetermined resolution, a predetermined compression ratio, an automatically set exposure time, and a reduced color depth.

28. The method of claim 20, further comprising generating at least one image with low resolution, a predetermined compression ratio, and a predetermined exposure time for the retention for subsequent data analysis.

29. The method of claim 28, further comprising sending the at least one generated image to an external unit for the retention for subsequent data analysis.

30. The method of claim 16, further comprising:
deciding to generate an image for a specific purpose;
supplying the camera settings associated with the specific purpose;
configuring the treatment chamber camera according to the supplied camera settings;
generating the image; and
supplying the generated image for use for the specific purpose.

31. A household appliance, comprising:
a treatment chamber; and
a treatment chamber camera including at least one variable camera setting, said treatment chamber camera being designed to generate a plurality of images from the treatment chamber at time intervals with the variable camera setting,
wherein the household appliance is designed to use at least two of the images for at least two different purposes, and to vary the camera setting of the treatment chamber as a function of purpose.

32. The household appliance of claim 31, constructed in a form of a household cooking appliance.

33. The household appliance of claim 32, wherein the household cooking appliance is an oven, the treatment chamber is a cooking chamber, and the treatment chamber camera is a cooking chamber camera.

34. The household appliance of claim 31, further comprising a control facility receiving the plurality of images from the treatment chamber camera.

35. The household appliance of claim 34, wherein the control facility comprises a data storage unit for storing the images.
